(19) United States
(12) Patent Application Publication
(10) Pub. No.: US 2010/0032623 A1
(43) Pub. Date: Feb. 11, 2010

(54) Method for producing a garnet phosphor

(75) Inventor: Stefan LANGE, Augsburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft Mit beschrankkter Haftung, Munich (DE)

(21) Appl. No.: 12/500,372

(22) Filed: Jul. 9, 2009

(30) Foreign Application Priority Data
Jul. 9, 2008 (DE) 10 2008 032 299.7

(51) Int. Cl. C09K 11/77

(52) U.S. Cl. 252/301.4 H; 252/301.4 R

(57) ABSTRACT

A method for producing a garnet phosphor that includes using cryolites as the flux. In particular YAG:Ce is suitable as the garnet.

### FIELD OF THE INVENTION

The invention is directed to a method for producing a garnet phosphor according to the preamble of Claim 1. Phosphors of this type are intended in particular for use in light sources, such as LEDs.

### BACKGROUND OF THE INVENTION

U.S. Pat. Nos. 6,596,195 and 6,409,938 teach the use of fluoride as a flux for garnets. However, the size distribution and morphology of the phosphor grains are thus rather unfavorably influenced.

### SUMMARY OF THE INVENTION

The object of the present invention is to disclose a flux for garnets, using which the size distribution and morphology of the phosphor grains may be positively influenced.

This object is achieved by the characterizing features of Claim 1.

Particularly advantageous embodiments are found in the subclaims.

Garnet phosphors such as YAG:Ce and substitution derivatives thereof, such as (Y,Gd,Lu)3(Al,Ga)5O12:Ce or (Y,Gd,Lu)3(Al,Ga)5 (O,F)12:Ce in particular, are among the most efficient and most used yellow to green-yellow emitting conversion phosphors for LEDs. Y is partially or completely replaced by Gd and/or Lu. Aluminum is partly or completely replaced by Ga. For optimum efficiency and processing capability, the morphology and size distribution of the phosphor particles are of decisive significance. The most narrow possible particle size distribution around a mean diameter which represents the best compromise in regard to brightness and processing capability is optimal. The mean particle size and the particle size distribution are substantially influenced by the flux used in the solid-state synthesis.

The proportion of F in (O,F) corresponds to the typical measure as disclosed in the prior art.

Typical fluxes are currently aluminum fluoride, or cerium fluoride or barium fluoride. These normally generate relatively small particles, which sinter together to form larger or smaller agglomerations. This results in a broad particle size distribution. In order to obtain fractions having the desired size distribution, post-processing steps are needed through classification (e.g., screening, sedimentation), which entail a high time expenditure and a significant reduction of the overall yield.

The novel fluxes M3AlF6 from the family of cryolites, where M=Na, K, Li, or NH4, preferably ammonium cryolite (NH4)3AlF6, sodium cryolite Na3AlF6, and potassium cryolite K3AlF6, allow a significantly improved control of the particle size with significantly narrower grain size distribution. The efficient flux properties cause improved growth of the primary particles. The tendency to form hard phosphor cakes is greatly reduced, whereby fewer troublesome cracked grains are generated during the processing. The necessity for subsequent classification is thus decreased or avoided entirely. In addition, potassium cryolite K3AlF6 improves the phase purity of the products and the cerium incorporation into the host structure of the garnet AxByOz:D.

Garnets of the type A3B5O12:D or also A3B5(O,F)12:D are preferred. In particular A=Y, Sc, lanthanides, B=Al, Ga, and D=Ce, Tb alone or in combination or each together with one of the co-activators such as Pr, Nd, Eu. A is particularly suitably predominantly Y or Tb, i.e., more than 50 mol-%. B is preferably predominantly Al, i.e., more than 50 mol-%. The activator D is preferably predominantly Ce, i.e., more than 50 mol-%. The proportion of F is preferably less than 1 mol-%.

The use of cryolites as a flux improves the absorption properties and the brightness of the phosphors. The yields and the required time and personnel expenditure for the processing are also significantly improved.

The establishment of the morphology and the size distribution may be influenced very well using cryolites.

The production method for producing a garnet phosphor AxByOz:D is executed as follows in principle:

a) grinding the oxides of A and B and adding a cryolite M3AlF6 as a flux where M=Na, Li, K, or NH4;

b) annealing in forming gas;

c) grinding and screening;

d) optional second annealing with grinding and screening.

### BRIEF DESCRIPTION OF THE DRAWINGS

The invention is explained in greater detail hereafter on the basis of multiple exemplary embodiments. In the figures:

FIG. 1 shows a particle size distribution of the phosphor YAG:Ce for various fluxes;

FIG. 2 shows an overview of the particle parameters of various samples from FIG. 1;

FIG. 3 shows the dependence of the mean diameter d50 of the phosphor particles as a function of the flux concentration.

### PREFERRED EMBODIMENT OF THE INVENTION

The components
9.82 g yttrium oxide Y₂O₃
2.07 g cerium oxide CeO₂
37.57 g terbium oxide Tb₄O₇
26.41 g aluminum oxide Al₂O₃
0.15 g sodium cryolite
   are mixed and ground together for two hours in a 250 ml polyethylene wide-neck flask with 150 g aluminum oxide balls of 10 mm diameter. Sodium cryolite is used as the flux. The mixture is annealed for three hours at 1550° C. in forming gas (nitrogen with 2.3 vol.-% hydrogen) in a covered corundum crucible. The annealed product is ground in an automatic mortar grinder and screened through a screen of 53 μm mesh width. The phosphor obtained corresponds to the composition (Y_{0.29}Tb_{0.67}Ce_{0.43})₃Al₅O₁₂. It has a strong yellow body color.

In a further exemplary embodiment, only Y2O3 is used as the starting material, but no Tb4O7, so that YAG:Ce results as the product.

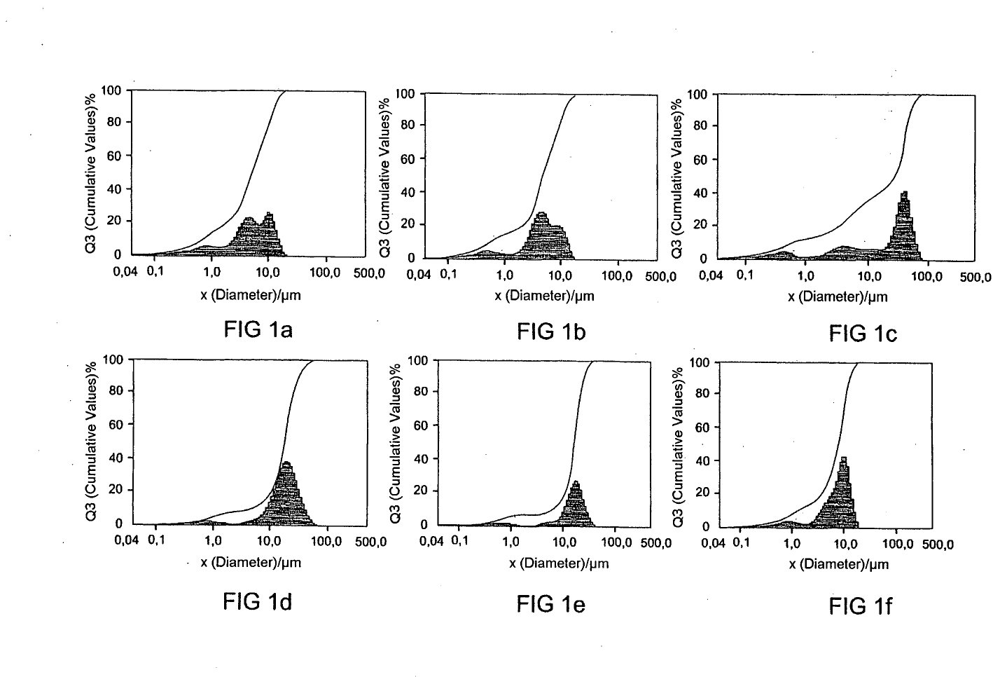

FIG. 1 shows the particle size distribution Q3 (cumulative) as a function of the diameter of the particles, with respect to six different samples having different fluxes. The fluxes used are:

FIG. 1a) CeF3 (sample a),

FIG. 1b) BaF2 in low concentration (sample b);

FIG. 1c) BaF2 in high concentration (sample c);

FIG. 1d) (NH4)3AlF6 (sample d);

FIG. 1e) Na3AlF6 (sample e); and

FIG. 1f) K3AlF6 (sample f).

It has been shown that a very narrow-band particle size distribution results upon the use of cryolites, while with normal fluorides the particle size distribution is broad and undesired secondary peaks occur.

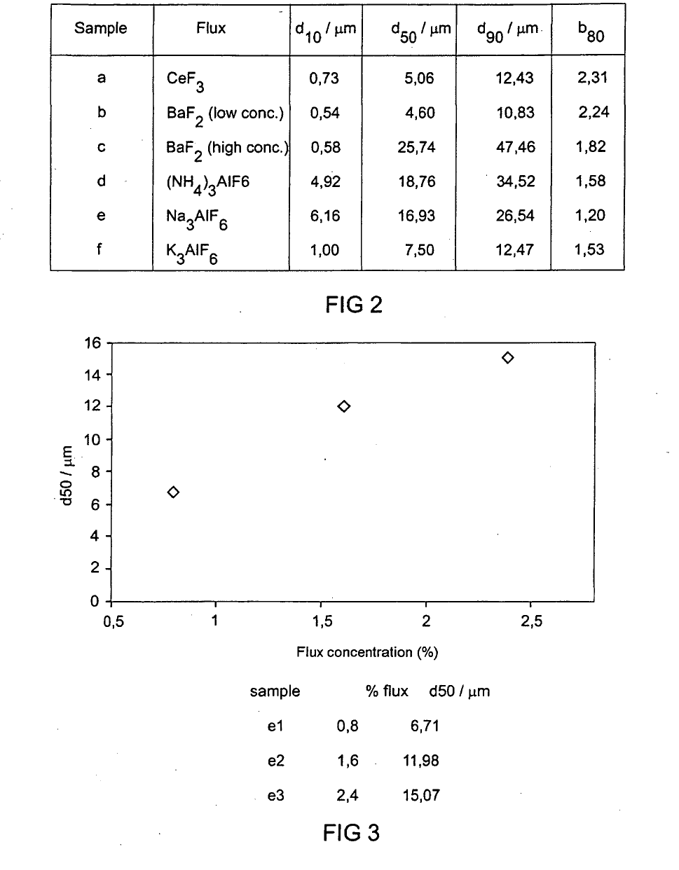

FIG. 2 shows a table which specifies the parameters d10, d50, d90, and b80 for the samples a) through f). In particular the small value for b80 in the case of the cryolites is noteworthy.

FIG. 3 shows how the particle size may be deliberately controlled via the flux concentration when cryolites are used. YAG:Ce was produced using Na3AlF6. The mean diameter d50 (in μm) may be set from approximately 6 to 16 μm, if the flux concentration is selected between 0.7 and 2.5 wt.-% per total mass of batch mixture.

The measuring points are: sample e1 at 0.8%/6.71 μm, sample e2 at 1.6%/11.98 μm, and sample e3 at 2.4%/15.07 μm.

When phosphors of this type are employed in a white LED together with an InGaN LED, a construction similar to that described in WO 97/50132 is used. For example, equal parts of phosphor according to example 1 and phosphor according to example 4 are dispersed in epoxy resin and an LED having an emission maximum of approximately 450 nm (blue) is enveloped using this resin mixture. The mixture of the blue LED radiation with the yellow phosphor emission typically results in this case in a color location of x=0.359/y=0.350, corresponding to white light of the color temperature 4500K.

The phosphors described above generally have a yellow body color. They emit in the yellow spectral range. Upon addition or sole use of Ga instead of Al, the emission shifts more in the green direction, so that in particular even higher color temperatures may be realized.

1. A method for producing a garnet phosphor AxBy(O,F)z:D, comprising the steps of:
a) grinding oxides of A and B and adding a cryolite M3AlF6 as the flux, where M=Na, Li, K, or NH4;
b) annealing in forming gas; and
c) grinding and screening.

2. The method according to claim 1, wherein the garnet phosphor has the structure A3B5O12:D or A3B5(O,F)12:D.

3. The method according to claim 1, wherein A=Y, Sc, lanthanides, B=Al, Ga.

4. The method according to claim 1, wherein D=Ce, Tb alone or in combination or each together with one of the co-activators Pr, Nd, and Eu.

5. The method according to claim 1, wherein more than 50 mol-% of A is Y or Tb.

6. The method according to claim 1, wherein more than 50 mol-% of B is Al.

7. The method according to claim 1, wherein more than 50 mol-% of D is Ce.
